(19) United States
(12) Patent Application Publication
(10) Pub. No.: US 2004/0041034 A1
(43) Pub. Date: Mar. 4, 2004

(54) Proportional fluid mixing system

(76) Inventor: William Harry Kemp, Clayton (CA)

Correspondence Address: Sequence Controls Inc., 150 Rosamond Street, Carleton Place, ON, K7C 1V2, CA

(21) Appl. No.: 10/233,387

(22) Filed: Sep. 3, 2002

(51) Int. Cl. G05D 23/13

(52) U.S. Cl. 236/12.12; 236/78 C

(57) ABSTRACT

A mixing valve having two different fluid inputs and at least one fluid outlet. The fluid inputs are adapted to be coupled to the fluid outlet in variable proportions according to mix ratio data provided by a controller means. An electric motor operated gear box is adapted to be coupled to the operating shaft of the mixing valve. A sensing probe is mounted in communication with the mixing valve outlet fluid and is adapted to be coupled to the controller means. Optional, electrically operated fluid solenoids are adapted to be coupled to the controller means. The controller means is provided with an output for switching the switching device between its first, second or third states in a predetermined sequence for inducing a polarity conditioned voltage signal. The power supply and dry cell battery are coupled to the AC mains for supplying a low-voltage, supply to the controller means.

### FIELD OF THE INVENTION

The present invention relates to devices used to control process variable setpoints such as temperature, viscosity or pressure of fluids supplying industrial, plumbing or other processes. A particular application of the present invention relates to supplying water at varying temperatures to plumbing fixtures such as showers, large medical bathing systems or as a master mixing valve supplying numerous plumbing fixtures simultaneously. More particularly, the present invention relates to a mixing valve comprising a hot and cold fluid inlet and one or more mixed fluid outlets, including a gear motor adapted to be coupled to said mixing valve. A controller comprising electronics for electrically operating the gear motor having one or more temperature sensors in thermal communication with the discharge fluid of said mixing valve. Includes a rechargeable battery to provide operation during power failure.

### DESCRIPTION OF THE PRIOR ART

Industrial fluid control systems often contain valves to mix two fluids in variable proportions according to assigned process variables such as temperature, viscosity or pressure. These applications contain motor driven valves adapted to be coupled to process sensors and programmable logic controllers. In such applications an engineering process will determine the relationship between the process variable and the feedback necessary to stabilize the mixed fluid output. Such closed loop control systems are well known to those skilled in the art.

Manually operated valves, many of which contain pressure and thermostatic balancing elements, are also common in every day life. These valve systems are often installed in bath and shower areas, to regulate the flow of bathing water and to ensure precise water temperature in varying supply water conditions. A typical example is a valve that maintains shower water temperature when another water appliance being operated. A sudden drain on the cold water supply may drop the cold water pressure, while leaving the hot water pressure relatively constant, thus increasing outlet water temperature due to an imbalance between hot and cold inlet water flow. It will be clear to those skilled in the art that a feedback process in industrial valve systems and common water plumbing designs rely on the same feedback and regulation means, although the implementation of such a process differs in the above examples.

Without departing from the scope of the invention, a particular adaptation shall be used to describe the background and description of the prior art and the invention, wherein the scope of application used will utilize the plumbing example cited.

Such plumbing valves may be constructed to contain either pressure or temperature balancing modules or both. Traditionally, pressure or temperature balancing functions is controlled by mechanical means contained within the valve casing. The user operates the valve by opening (rotating) the valve stem and adjusting the water temperature to the desired setting. Once the user has selected the desired temperature setpoint by touching the water outlet temperature, sudden changes in water inlet pressure or temperature will not seriously affect the outlet (mixed) temperature.

A pressure-balancing module installed within the water control valve can rapidly adjust to varying pressure conditions, ensuring water outlet temperature remains essentially constant. Likewise, a thermostatic module installed in a similar valve can adjust to varying inlet water temperature changes; ensuring water outlet temperatures remain constant.

A person skilled in the art will recognize that water pressure variations tend to require high-speed correction, due to the velocity of pressure waves within the conducting fluid. Short term lowering of one inlet water pressure can therefore be corrected by an essentially, simultaneous and equal pressure reduction at the other water inlet, without regard to mixed, outlet temperature. Provided both inlet water temperatures remain essentially constant, the outlet temperature will remain static as both inlet water pressures are modulated, during the pressure imbalance period.

Mechanical temperature balancing valves utilize an internal cartridge, which is in fluid communication with the mixed outlet water. A sudden change in water temperature will cause the cartridge assembly to make adjustments in the ratio of hot to cold inlet water flow, thus ensuring that the outlet water temperature remains essentially static.

Mechanical temperature balancing valves tend to operate at a slower rate of change than pressure balancing cartridges, due to limitations of technology employed in their construction. Further, valve configurations are generally based on water flow at a given static pressure. For typical residential applications, a water flow of 30 liters per minute at 3 bar inlet pressure is common. For larger institutional bathing systems, flows of 90 liters per minute at 3 bar inlet pressure are desired. Higher flow decreases bath fill times in institutions such as nursing homes and hospitals, where cost must be controlled. One drawback of temperature balancing valves and many electronically controlled mixing valves described in the prior art is the inability to stabilize outlet water temperature at high flow rates. This is due to several technical issues such as the velocity of water in the plumbing lines, the thermal lag of the water temperature sensor and mechanical overshoot in the thermal governor cartridge assembly or motor/belt drive of electronically controlled thermostatic valves.

It will be apparent from the above descriptions that pressure-balancing valves cannot ensure the stability of mixed water temperature in conditions where water supply temperature is subject to variation. Similarly, a temperature-balancing valve may not necessarily ensure the stability of mixed water temperature, in conditions of varying inlet water pressure, due to slower response time.

In applications where one or the other type of balancing valve may not ensure the stability of outlet water temperature, a valve utilizing both pressure and temperature balancing is often used. Such high-flow pressure and temperature balancing valves are often employed in hospital and institutional areas, at high cost, in an effort to overcome the inherent limitations of each balancing technology.

In many applications, the degree of outlet temperature regulation is controlled by safety codes administered by the country where installation has taken place. This is especially true of applications in hospitals, nursing and assisted living homes or private residences where the concern of scalding of the very young, elderly or infirm is a concern. Such safety codes outline the degree of outlet (mixed) water temperature variation as a function of desired set point temperature, when the inlet water temperature, or pressure is varied. One such safety code used in the United States of America is known as A.S.S.E.—1016, which is administered by the American Society of Sanitary Engineering for Plumbing and Sanitary Research.

Accordingly, the most common prior art methods for regulating the temperature of outlet water to plumbing fixtures is with pressure, temperature or combined balancing valves, meeting applicable safety code as disclosed above. It will be clear to those skilled in the art, that a safety code is essentially the process control rule for which the feedback and corrective actions are “programmed” into the design of the temperature and/or pressure balancing cartridges.

A drawback of these safety codes is they provide the minimum standards to be employed in a given condition. Experience has shown that standards such as A.S.S.E 1016 provide adequate safety against scalding in the general population, but do not take into account maximum absolute water temperature or more subjective issues such as water temperature stability, particularly at lower flow rates. Elderly people tend to be more sensitive to both rapidly fluctuating and high overall water temperature, which most safety codes do not consider. It is with this need in mind that medical manufacturers in particular try to exceed the minimum safety standards by looking to valve manufacturers to improve valve thermal performance.

Automatic means for regulating water temperature have been disclosed in the prior art and includes a temperature controlled mixing fitting connected to hot and cold water inlet pipes, operated by an electromechanical motor module and fitted with a manual control means for operation during to a power failure. The electromechanical motor is adapted to be electrically connected to a temperature sensor for automatically controlling the flow of hot and cold water discharged through the mixing fitting (U.S. Pat. No. 4,842,191).

Another prior art patent teaches the use of a motor driven mixing tap, wherein alternating amounts of hot and cold water are discharged into a common outlet. (U.S. Pat. No. 4,768,705).

Another prior art patent describes the use of a shut off valve actuated via a temperature sensitive electric one-way solenoid (U.S. Pat. No. 5,090,436).

Another prior art patent describes the use of mechanically independent valve means for controlling the flow of hot and cold water to a water delivery channel. Includes a data processing means having outputs connected to means for controlling said valve means (U.S. Pat. No. 4,420,811).

Another prior art patent teaches the use of a modular water temperature control unit comprising a temperature controlled motor and battery power supply which may be retrofit into existing manual water mixing valves (U.S. Pat. No. 5,944,255).

Prior art inventions which stop the flow of water do not address the need for continuous water flow at a preset temperature.

Systems that rely on temperature sensing elements mounted in fluid communication with the outlet water do not teach how to prevent scalding as a result of sudden changes in inlet water pressure.

Systems that rely on internal thermostatic balancing cartridges may not work in medical institutions due to the pre-tempering of the hot water supply inlet. Most thermostatic valves require a minimum differential temperature between the cold and hot water supply inlet. Due to pre-tempering, the differential temperature is insufficient to allow the balancing module to function properly.

Systems that attempt to connect electronic temperature controls to mixing valves of unspecified construction do not teach how they meet world-wide safety standards.

Prior art inventions that use manual control means for backup during power failure are not considered commercially acceptable and offset the need for a device which is exclusively electronically operated and fail safe. Persons operating the valve that have weakened hands due to arthritis or other disability often experience pain or even total inability in attempting to rotate or close the valve manual operator means.

Prior art inventions such as described in U.S. Pat. No. 5,944,255 utilise a DC dry cell power supply which requires replacement from time to time. Accessing such battery compartments in a wet location such as a shower area is likely to cause corrosion and reduce reliability. Additionally, changing said dry cells is likely to be considered unacceptable commercially.

Prior art inventions such as described in U.S. Pat. No. 5,090,436 and U.S. Pat. No. 4,768,705 do not teach how the power supply circuits are constructed. If external AC mains supply connection is assumed, there is an obvious safety hazard due to electrocution. The present invention teaches the use of AC mains supply in an electrically safe manner, which is a requirement of worldwide safety standards administrators.

Systems that rely on flexible couplings, such as timing belts or chains between the drive motor and valve unit will suffer from system instability or hunting during periods of thermal instability, due to lack of torsional stiffness of such coupling.

The present invention allows a number of users to preset temperature and running time for their personal preference or safety. Nursing homes may select maximum overall temperature setpoints to levels low enough to prevent scalding infirm persons, a factor not considered in current safety codes. Such preset temperature and operating times are stored in a memory means of the controller for future selection.

The present invention relates to valves without any form of internal, temperature and/or pressure balancing cartridges of construction, including an electrical operator means as will be presently described.

The present invention also provides numerous safety features such as high water temperature or level alarms. Further, an optional, external electrically operated solenoid valve may be adapted to be coupled to the control means and closed in the event of malfunction in the mixing valve or motor drive assembly, such solenoid increasing reliability and safety.

The present invention also provides for auxiliary interface inputs and outputs allowing the valve to be connected to other related devices. This may include external water level detection means for automatic bath filling, water heater control to maintain selected bath water temperature, remote temperature probe means to display bath water temperature, a master off switch for emergency valve closure or any other interface components that may be required to modify the process control rules as determined by the commercial application of the present invention.

### SUMMARY OF THE INVENTION

According to an aspect of the present invention, there is provided an apparatus, comprising a gear motor driven mixing valve for receiving two different fluid inputs and providing a mixed fluid outlet, in variable proportions according to process variables such as temperature, viscosity or pressure setpoint data provided by a controller means, the apparatus comprising:

a mixing valve having a first fluid inlet, a second fluid inlet and at least one discharge outlet, for blending fluid inflows coupled respectively from said first and second fluid inlets so as to cause said mixing valve outlet to supply mixed fluid at a selected process variable setpoint;

a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;

an electric motor driven gear box adapted to be coupled to the operating shaft of said mixing valve;

optional user controls for providing process mix ratio data signals;

at least one process sensing probe mounted in communication with said mixing valve outlet fluid, said sensing probe adapted to be coupled to an interconnection means and controller means;

one or more optional, electrically operated fluid solenoids hydraulically coupled in series to said mixing valve outlet and electrically coupled to an interconnection means, wherein the fluid solenoid is operable in a first state wherein significant fluid flow is prevented or in a second state wherein fluid flow through the solenoid valve is substantially undisturbed, said electrical interconnection coupled to the controller means;

a controller means for receiving the user process mix ratio data, comprising an input for receiving said process sensing probe telemetry, a switching device for switching the switching device between its first, second or third states in a predetermined sequence for inducing a polarity conditioned voltage signal, an optional output for controlling said electrically operated fluid solenoid valve to control the flow of said mixed fluid outlet, an interface means for providing bi-directional telemetry signals to externally connected equipment;

a power supply means, coupled to the AC mains source for supplying a low-voltage, supply to the controller means;

an optional dry cell battery coupled to the controller means and low-voltage direct current power supply means.

According to another aspect of the invention there is an apparatus comprising an electric gear motor driven mixing valve for receiving cold and hot water supplies and providing a mixed water outlet at a default or telemetry signal defined water temperature setpoint provided by a controller means, the apparatus comprising:

a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;

an electric motor driven gear box adapted to be coupled to the operating shaft of said mixing valve;

a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;

telemetry input for providing water temperature input signals;

at least one temperature sensing probe mounted in thermal communication with said mixing valve outlet water, said temperature sensing probe adapted to be coupled to an interconnection means and controller means;

one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;

a controller means for receiving the telemetry water temperature input, an input for receiving said outlet water temperature signal from temperature sensing probe, an output for switching the switching device between its first, second or third states in a predetermined sequence for inducing a polarity conditioned voltage signal, an optional output for controlling said optional electrically operated water solenoid valves to control the flow of said water outlet, an interface means for providing communication signals to externally connected equipment;

a power supply means, coupled to the AC mains source for supplying a low-voltage, direct current to the controller means.

According to another aspect of the invention there is provided an apparatus operable in a wet, electrically hazardous environment, comprising an electric motor operated gearbox mixing valve for receiving cold and hot water supplies and providing a mixed water outlet to a shower, bath or other plumbing fixture, at a default or user defined water temperature setpoint provided by a controller means, the apparatus comprising:

a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;

an electric motor driven gear box adapted to be coupled to the operating shaft of said mixing valve;

a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;

user controls for providing water temperature input signals;

at least one temperature sensing probe mounted in thermal communication with said mixing valve outlet water, said temperature sensing probe adapted to be coupled to an interconnection means and controller means;

one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;

a controller means for receiving the user instructions and for transmitting status information to the display means, comprises an input for receiving said outlet water temperature, an output for switching the switching device between its first, second or third states in a predetermined sequence for inducing a polarity conditioned voltage signal, an optional output for controlling said electrically operated water solenoid valve to control the flow of said water outlet, an interface means for providing bi-directional communication signals to externally connected equipment;

a power supply means, coupled to the AC mains source for supplying a low-voltage, isolated, electrically safe, direct current to the controller means;

a dry cell battery coupled to the controller means and low-voltage direct current power supply means.

According to another aspect of the present invention, there is provided a method for operating a gear motor driven mixing valve for receiving two different fluid inputs and providing a mixed fluid outlet, in variable proportions according to process variables such as temperature, viscosity or pressure setpoint data provided by a controller means, comprising:

a mixing valve having a first fluid inlet, a second fluid inlet and at least one discharge outlet, for blending fluid inflows coupled respectively from said first and second fluid inlets so as to cause said mixing valve outlet to supply mixed fluid at a selected process variable setpoint;

a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;

an electric motor driven gear box adapted to be coupled to the operating shaft of said mixing valve;

optional user controls for providing process mix ratio data signals;

at least one process sensing probe mounted in communication with said mixing valve outlet fluid, said sensing probe adapted to be coupled to an interconnection means and controller means;

one or more optional, electrically operated fluid solenoids hydraulically coupled in series to said mixing valve outlet and electrically coupled to an interconnection means, wherein the fluid solenoid is operable in a first state wherein significant fluid flow is prevented or in a second state wherein fluid flow through the solenoid valve is substantially undisturbed, said electrical interconnection coupled to the controller means;

a controller means for receiving the user control, comprises an input for receiving said process sensing probe telemetry, a switching device for switching the switching device between its first, second or third states in a predetermined sequence for inducing a polarity conditioned voltage signal, an optional output for controlling said electrically operated fluid solenoid valve to control the flow of said mixed fluid outlet, an interface means for providing bi-directional telemetry signals to externally connected equipment;

a power supply means, coupled to the AC mains source for supplying a low-voltage, supply to the controller means;

a dry cell battery coupled to the controller means and low-voltage direct current power supply means.

the method comprising the steps of;

(a) waiting for user start command;

(b) opening optional water solenoid valve;

(c) loading user defined or default outlet water temperature setpoint;

(d) reading current water temperature from sensor

(e) adjusting valve opening to regulate outlet water temperature to equal desired setpoint temperature.

According to another aspect of the invention there is a method of controlling an electric gear motor driven mixing valve for receiving cold and hot water supplies and providing a mixed water outlet at a default or telemetry signal defined water temperature setpoint provided by a controller means comprising:

a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;

an electric motor driven gear box adapted to be coupled to the operating shaft of said mixing valve;

a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;

telemetry input for providing water temperature input signals;

at least one temperature sensing probe mounted in thermal communication with said mixing valve outlet water, said temperature sensing probe adapted to be coupled to an interconnection means and controller means;

one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;

a controller means for receiving the telemetry water temperature input, an input for receiving said outlet water temperature signal from temperature sensing probe, an output for switching the switching device between its first, second or third states in a predetermined sequence for inducing a polarity conditioned voltage signal, an optional output for controlling said optional electrically operated water solenoid valves to control the flow of said water outlet, an interface means for providing communication signals to externally connected equipment;

a power supply means, coupled to the AC mains source for supplying a low-voltage, direct current to the controller means;

the method comprising the steps of:

(a) waiting for user start command;

(b) opening optional water solenoid valve;

(c) loading user defined or default outlet water temperature setpoint;

(d) reading current water temperature from sensor adjusting valve opening to regulate outlet water temperature to equal desired setpoint temperature.

According to another aspect of the invention there is provided a method for operating in a wet, electrically hazardous environment, an electric motor operated gearbox mixing valve for receiving cold and hot water supplies and providing a mixed water outlet to a shower, bath or other plumbing fixture, at a default or user defined water temperature setpoint provided by a controller means, comprising:

a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;

an electric motor driven gear box adapted to be coupled to the operating shaft of said mixing valve;

a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;

user controls for providing water temperature input signals;

at least one temperature sensing probe mounted in thermal communication with said mixing valve outlet water, said temperature sensing probe adapted to be coupled to an interconnection means and controller means;

one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;

a controller means for receiving the user instructions and for transmitting status information to the display means, comprises an input for receiving said outlet water temperature, an output for switching the switching device between its first, second or third states in a predetermined sequence for inducing a polarity conditioned voltage signal, an optional output for controlling said electrically operated water solenoid valve to control the flow of said water outlet, an interface means for providing bi-directional communication signals to externally connected equipment;

a power supply means, coupled to the AC mains source for supplying a low-voltage, isolated, electrically safe, direct current to the controller means;

a rechargeable dry cell battery coupled to the controller means and low-voltage direct current power supply means.

the method comprising the steps of;

(e) waiting for user start command;

(f) opening optional water solenoid valve;

(g) loading user defined or default outlet water temperature setpoint;

(h) reading current water temperature from sensor

(i) adjusting valve opening to regulate outlet water temperature to equal desired setpoint temperature.

Other advantages, objects and features of the present invention will be readily apparent to those skilled in the art from a review of the detailed description of the preferred embodiment in conjunction with the accompanying drawings and claims.

### BRIEF DESCRIPTION OF THE DRAWINGS

The embodiments of the invention will now be described with reference to the accompanying drawings, in which:

FIG. 1 is a schematic view of a fluid flow model through a simplified valve body for mathematical modelling purposes, including fluid temperature sensing thermistor, controller means and stepper motor/gearbox implementation;

FIG. 2 is a mathematical model of one implementation of the present invention utilising temperature as the process setpoint;

FIG. 3 is a graphical representation of a valve drive system with low torsional stiffness or backlash;

FIG. 4 is a graphical representation of a valve drive system with high torsional stiffness or low backlash;

FIG. 5 is a graphical representation of thermistor phase advance theory;

FIG. 6 is one embodiment of the present invention, detailing a block diagram schematic of the controller and user display means, including an exploded view of a typical mixing valve construction with motor operated gear box and interconnection means to said controller means. Drawing includes a water temperature sensor probe in thermal communication with mixed outlet water flow. Includes optional water solenoid valve in fluid connection to said pressure and/or temperature balancing valve outlet and electrical interconnection means with said controller means; and

FIG. 7 is a flow chart illustrating the operational sequence and input and output functions of the controller of the present invention.

With respect to the above drawings, similar references are used in different Figures to denote similar components.

### DETAILED DESCRIPTION OF THE INVENTION

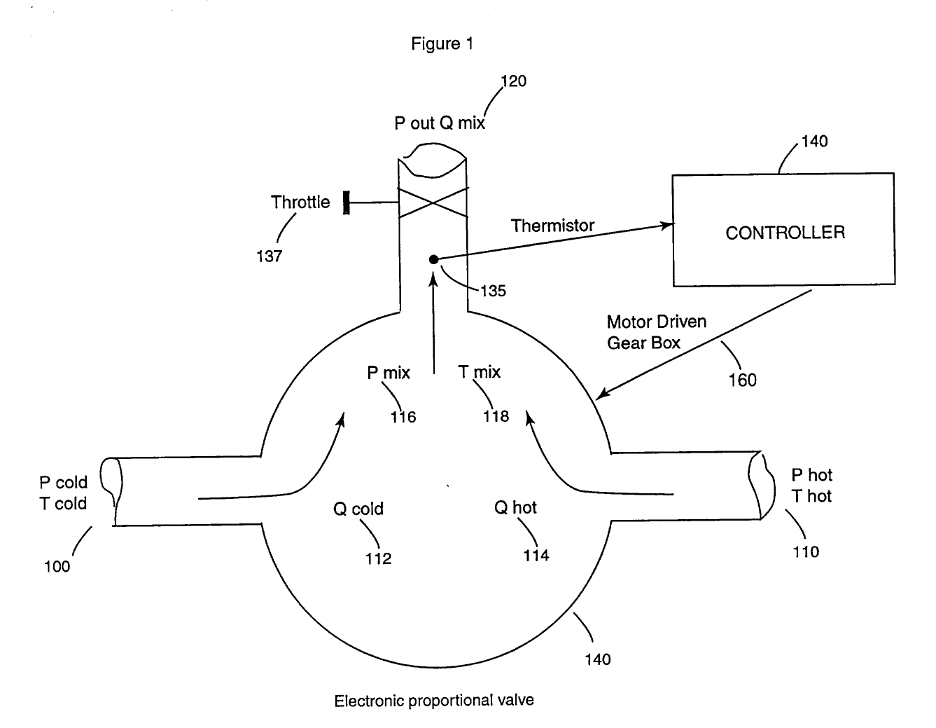

Referring to FIG. 1 there is shown a simplified section view of a simplified fluid flow model of the present invention. This drawing details the items necessary to understand the pressure, flow and thermal dynamics of fluids and the components necessary to measure a process variable and provide closed loop feed back to achieve a desired setpoint. In order to simplify the understanding of the present invention, all descriptions with relation to the drawings will assume nominally cold and hot water inlets resulting in a mixed temperature setpoint at the outlet.

Cold water is supplied under pressure at first inlet 100 and hot water is supplied under pressure at second inlet 110. Cold water will then flow into mixing area 112, while hot water will flow into mixing area 114. Depending on degree of angular rotation of mixing spool 442, cold and hot water will mix as they flow towards the valve outlet. Mixed water now provides a mixed dynamic pressure 116 and a mix thermal dynamic 118. At a point close to initial water mixing, a temperature sensing element 135 is installed in thermal communication with mixed water 116 and 118 flowing towards the valve outlet. In order to simulate real life plumbing systems, a degree of backpressure is required. Throttle 137 simulates the effects of long plumbing runs, fluid restrictions or other fluid frictional elements that would be present in actual plumbing systems. Water flowing under pressure 120 exits the mixing valve simulation.

As the complete mathematical model requires measuring and feedback control, temperature sensing element 135 is adapted to be coupled to a controller 140 and motor driven gear box assembly 160, which in turn simulates the valve demand, reflecting the proportion of cold to hot water mix.

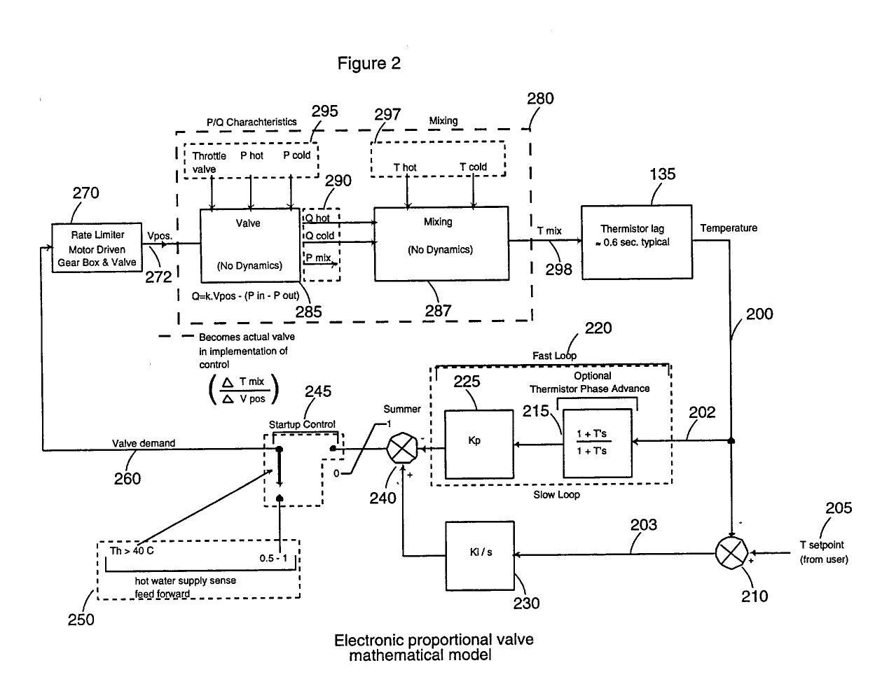

Referring now to FIG. 2, there is shown the mathematical model of the present invention, with regard to the fluid flow model of FIG. 1. Those skilled in the art will recognise this drawing as closed loop feedback model. Such a model is used to determine controller 40 characteristics with respect to the ability of the system to regulate process input variable to maintain desired setpoint. The present invention contemplates a nominally cold water inlet, a nominally hot water inlet and attempts to vary valve angular position to cause mixed water outflows to match desired water temperature setpoint.

Mixing valve 140 is shown in model format 280 with pressure, flow and plumbing system restrictions (throttle valve) characteristics implemented at 295. Inlet water flow characteristics 112 and 114 are dependant on mixing valve angular position 272. Corresponding inlet flows after application of valve angular position are calculated, ratio flow characteristics 290 are applied to mixing characteristics model 287. Cold and hot water inlet temperatures are applied to the mixing characteristic model 287 completing the valve pressure, temperature and flow circuit by delivering a mixed outlet water temperature 298. Outlet water temperature 298 is detected by water temperature sensor 135 which contains a nominal thermal time constant, which in the preferred embodiment of the invention is 0.6 seconds.

A time delayed temperature of the mixed outlet water is applied to temperature bus 200 which communicates with a “fast loop” 220 via interface 202 and to a summing device 210. User temperature setpoint 205 is applied to summing device 210 which creates a error signal 203 which is equal to the difference between the actual steady state mixed outlet water temperature 298, delayed by water temperature sensor time constant 200. Steady state temperature error signal 203 is applied to integrator 230 which in turn delivers a slow-speed or steady state change valve position error signal at summing device 240. Without regard to error signals generated by fast loop 220, summation circuit 240 feed forward valve position or demand signal 260 directly to rate limiter model of motor driven gear box and valve 270. Rate limiter 270 allows for the inherent limitation in angular acceleration of the motor driven gear box and valve due to their mass and rotational friction. After application of inherent delays imposed by rate limiter 270, valve angular position 272 is corrected.

Now with respect to “fast loop” 220 thermal effects, time delayed mixed water temperature 202 is either of water temperature sensor (thermistor) phase advance 215 or directly to proportional control 225. The effect of either thermistor phase advance or proportional control is to compensate for said thermistor time constant and to provide corrective signals to summation circuit 240 caused by transient errors in valve mixed water outlet temperature. Such transient errors may be caused by momentary fluctuations in inlet water pressure or flow, but occur at such high speed as to not effect the steady state (average) water temperature.

A person skilled in the art will understand that this arrangement of adjusting said steady state water temperature slowly and creating a high speed or momentary loop due to disturbances in inlet water pressure or temperature, forms two distinct bands of operation, being the high speed or disturbance band and the set point or steady state band. Controller 40 shall operate at a predetermined speed such that adjustments of the steady state setpoint are completed at a lower rate of speed than adjustments of the disturbance band. Should controller 40 operate the steady state too quickly, or the transient band too slowly, this will cause process interference, thus causing instability in the valve demand (position) 260 signal and mixed water outlet 290 temperature.

Startup conditions of the mixing valve system may incur situations which may not be present during normal operation. For example the nominally hot water inlet may have cooled, thus causing the valve demand position to move to the “maximum hot” position. Should water flows be very high, inlet water velocity will also be high. In such a condition, inlet hot water temperature may increase rapidly, beyond the ability for the control system to regulate the mixed outlet temperature within the desired limits. A hot water inlet feed forward compensation model 250 and control circuit 245 is provided wherein should hot water inlet temperature be below a given setpoint, the valve demand position is forced to a mix proportion that will not cause outlet mixed water temperatures to exceed the desired maximum.

The apparatus of the present invention incorporates all of the described elements in the physical implementation of the mixing valve 280=140, motor operated gear box 270=160, water temperature sensor 135=135, user input device 205=60, or controller means 225 or 215 and 210 and 220 and 230 and 240 and 245 and 250 and 260=40.

A person skilled in the art will understand that such a model will determine with a high degree of certainty that controller 20 will meet the criteria required to meet the process control requirements. In the preferred embodiment of the present invention, the process variable requires meeting the criteria of applicable safety codes.

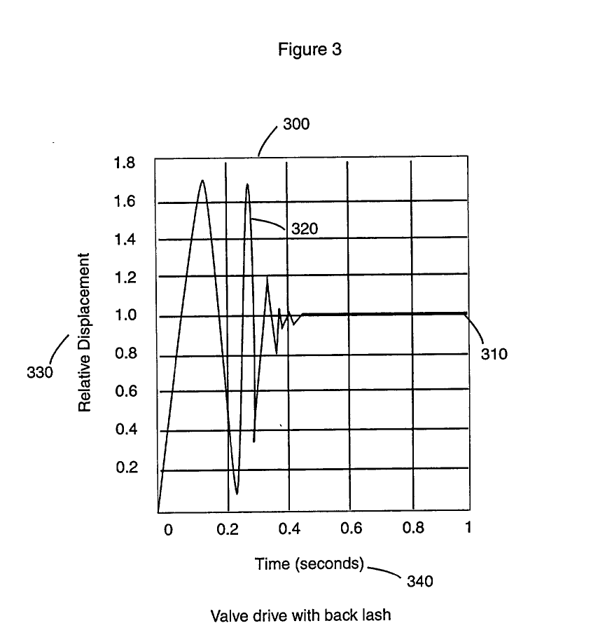

Referring now to FIG. 3, there is shown an X/Y graphical representation of a mixing valve drive system with backlash. Valve backlash may occur when, for example, the output drive shaft of the motor operated gear box 270 and 460 is connected to the input shaft of the mixing valve 272 and 449 by a coupling means which does not have a high degree of torsional stiffness.

In the example graph, the Y or vertical axis shows the relative displacement of the valve input shaft 330 (and thus the angular position of the mixing spool 442 and relative proportion of hot to cold water inlet mix) as a result of unwinding of said coupling, in relation to time 340. As the controller means 40 attempts to settle to a newly calculated valve demand (position setpoint) 310 and 260, the coupling unwinds 320. Such a phenomenon introduces additional instability into the controller feedback, thus limiting controller feedback gain and compensation for water temperature sensor time constants.

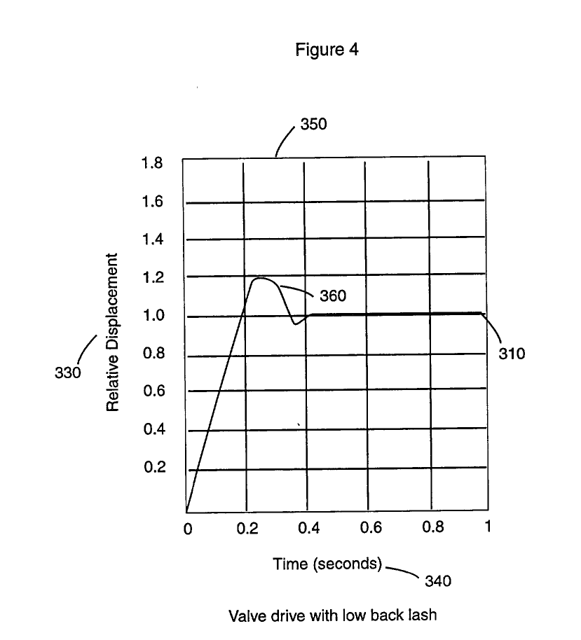

Referring now to FIG. 4, there is shown an X/Y graphical representation 350 of the preferred embodiment of the directly coupled motor operated gear box and mixing valve 360, of the present invention, on the same axis as FIG. 3 (330 and 340 and setpoint 310). A direct drive coupling provides higher torsional stiffness and limits the degree of settling time required for the mixing valve to move to the requested position.

Such torsional stiffness allows higher controller gain and response time, thus helping to ensure compliance with applicable safety codes.

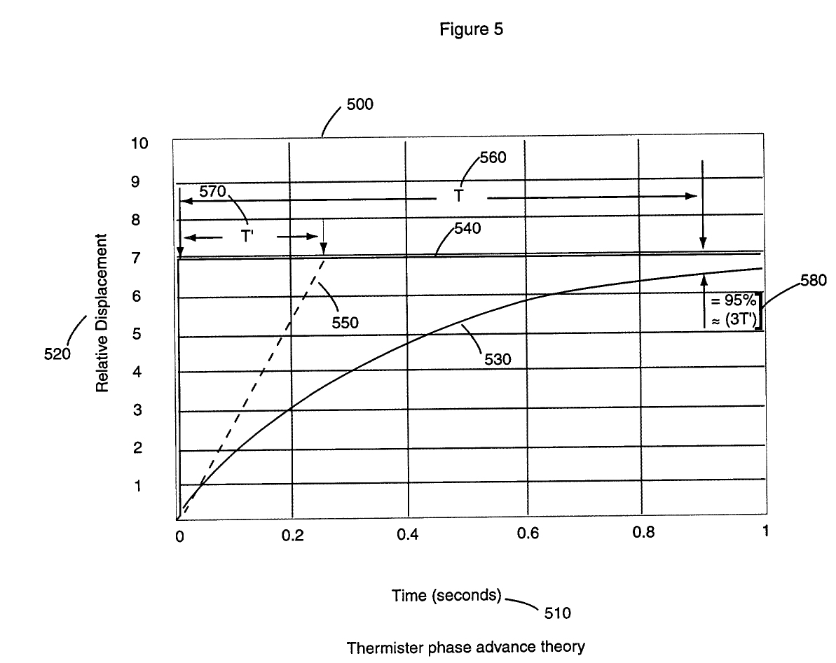

Referring now to FIG. 5, there is shown an X/Y graphical representation of a typical water temperature sensor 530 thermal time constant expressed as time in seconds on the X axis 510 to relative temperature on the Y axis 520, when applied through a step change in actual temperature 540. An actual thermal response lag (T) 560 can be reduced to a value of (T′) denoted by predictive curve 550. This may be expressed by saying that thermal lag (T)=(3T′) using phase advance prediction.

Alternatively, thermal phase advance prediction may be accomplished using proportional gain application 225 to actual water temperature sensor data. Modelling of the controller system as described in FIG. 2 disclosure will determine which function is best suited to the given application.

Excessive thermal time constants within the controller means limit the transient response time of the present invention and must be as low as possible without introducing controller instability due to excessively high gains or insufficient signal to noise ratios. A person skilled in the art will be familiar with controller gains, signal to noise ratios, thermal phase advance and proportional, integral control laws necessary to ensure high speed process response without controller instability.

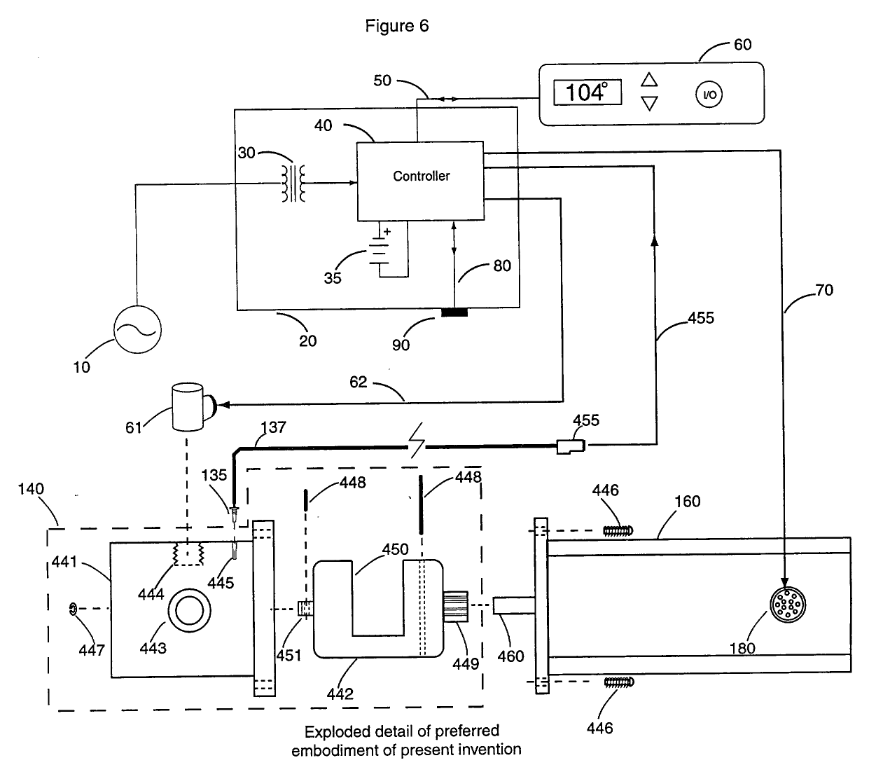

Referring to FIG. 6, there is shown an embodiment of the present invention wherein the previously described control laws are now applied to the apparatus shown wherein first inlet fluid is nominally cold water, the second inlet fluid is nominally hot water and the process variable and setpoint are water temperature. The present invention utilises a mixing valve 140 that is constructed to allow proportional mixing between the first and second fluid inlets. Valve 140 is constructed as to prevent excessive backpressure or flow resistance to the fluids entering the first or second fluid inlets or mixed fluid outlet. Additionally, mixing valve 140 is constructed with due regard as to the nature of the fluids flowing within the mixing valve and the materials used in construction of seal 448, mixing spool 442 or valve body 441.

A motor driven gear box 160 is coupled to said valve 140 in such a manner as to allow an electrical control signal 70 from valve control system 20 and in particular controller means 40 to adjust the rotational position of the motor driven gear box 160, its output shaft 460 and valve input shaft 449. Rotation of valve input shaft 449 adjusts the proportion of the mixed outlet fluid at port 444.

The construction of the valve 140 of the present invention shall now be described with continued reference to FIG. 6. The complete mixing valve assembly 140 comprises a valve body 441 with one inlet port 443 visible in this view, an outlet port 444 shown at right angles to first inlet port 443. In the preferred embodiment of the invention, the second inlet port which is not visible in this view, is placed 180 degrees opposite to first inlet port 443. A mixing spool 442 is constructed to create an eccentric mixing area 450 that will allow fluid to enter this area in varying proportion from either the said first or second fluid inlets, depending on the angle of valve input shaft 449. The mixing spool is constructed so as to accept a first and second sealing “o” ring 448 installed on its diameter, creating a sealed, fluid proof chamber when inserted into valve body 441. A retaining clip 447 attached at axle 451 holds mixing spool 442 in place. This arrangement of rotational spool 442 and “o” ring seals 448 allows input shaft 449 to rotate through 360 degrees of angle. Input shaft 449 is fabricated with an internal spline which allows coupling to motor driven gear box output shaft 460. Such a coupling arrangement allows for high torsional stiffness which reduces backlash.

The electrical and control circuits of the present invention shall now be described with continued reference to FIG. 6. The valve control system 20 comprises a double insulation power supply 30 constructed to provide sufficient electrical and mechanical isolation between the source of a.c. mains supply 10 and the user accessible components, such as display/keypad 60 or optional telemetry interface 90. Power supply 30 is constructed so as to reduce inductive, capacitive or other leakage currents to a level to eliminate the risk of electrical shock, typically under 0.5 milliamperes of current. A person skilled in the art will be familiar with the construction of such power supplies. Power supply 30 is adapted to be coupled to a controller 40 and rechargeable drycell battery 35. In the preferred embodiment of the invention, drycell (35) is a rechargeable nicad battery, nominally rated at 12 Volts and 1,000 milliampere/hours capacity. Such an arrangement of drycell battery 35 and power supply 30 will allow controller 40 to either operate for extended periods of time without a.c. mains supply 10 or for small periods of time. Should drycell battery 35 be of a relatively small capacity, the failure of a.c. mains supply 10 would cause controller 40 to recognise this failure with a short time period and cause motor operated gear box 160 to close valve 140, prior to expiry of drycell battery 35 capacity. Should drycell battery 35 be of a relatively larger capacity, controller 40 and motor operated gear box 160 would be able to operate for extended periods of time. When a.c. mains supply 10 is present, power supply 30 provides double insulated, safe, low-voltage power to controller 40, which is operably coupled to said drycell 35. Such an arrangement provides for continuous charging of drycell 35. Such an arrangement will provide for the fail-safe closure of mixing valve 140 and the stoppage of outlet water flow 120.

Optional water solenoid 61 is adapted to be coupled to controller 40, through interface 62 in such a manner that upon failure of the a.c. mains supply 10, said water solenoid valve 61 will return to its normally closed position.

The arrangement of valve 140 and optional water solenoid 61 is redundant where absolute stoppage of outlet water flow is required. In certain applications, valve 140 is not equipped with a stop position, such that rotation of valve input shaft 449 will cause steady state water temperature to vary between a minimum and maximum value. Such valves are known in the art as master mixing valves. A person skilled in the art will recognise that one or more optional water solenoid valves 61 and water temperature sensing probes 135 could be adapted to be coupled to controller 40 through a manifold arrangement to said master mixing valve. Such an arrangement would allow separate water plumbing connections to one or more appliances, thus requiring only one master mixing valve. An example of such a system would have one water solenoid valve feed a bath fill faucet, while a second water solenoid valve would supply a shower spray head.

Controller 40 is adapted to be coupled to several input and output interfaces. A user keypad and display assembly 60 provides a means of status signalling and temperature display to the user. Such status signalling is communicated to controller 40 by interface 50. The user keypad and display assembly 60 may contain numerous features such as the storing of default water temperature, several user selected water temperature setpoints and water flow timers, water temperature display and diagnostic information to alert the user of failures with the apparatus of the present invention.

A water temperature sensor 135 is mounted in thermal communication with mixed water at fitting 445. Temperature sensor 135 is adapted to be coupled to controller 40 by interface 137, electrical interface connector 455. A person skilled in the art will recognise the necessity of reducing the temperature sensor 135 time constant, by placing said sensor in a location that provides exposure to well mixed fluid, in close proximity to the valve outlet 444.

An optional, auxiliary interface connector 90 is provided and is adapted to be coupled to controller 40 through interface 80. Said auxiliary interface connector 90 provides a means for interconnection to optional external signalling equipment which may provide additional telemetry signals to controller 40. Such telemetry signals may include a bath water level sensor to signal to controller 40 that a bath is full and thus stop outlet water flow. Another telemetry signal includes an additional water temperature signal, adapted to be coupled to the water in a bathing vessel. Such water temperature signal may provide additional safety control by verifying thorough comparison of readings with valve water temperature sensor 135. Additionally, such bath vessel water temperature sensor may signal the need for additional hot or cold water to adjust the bath vessel water temperature.

In the preferred embodiment, motor driven gear box 160 comprises a high speed, stepping motor adapted to be coupled to a gear drive assembly which has low backlash. Low backlash increases dynamic response, by preventing wind up in the gear coupling, which in turn offers high torsional stiffness. The motor driven gear box 160 comprises an spline output shaft 460 which is adapted to be coupled to valve input shaft 449. Such an arrangement of a high speed motor coupled through a gear box and directly coupled spline arrangement 449 and 460 provides improved dynamic response by reducing settling time of the valve 140 in reaching desired setpoint. Further, high rotational speed and rapid adjustment of valve angular position ensures rapid correction to changing process conditions.

Motor operated gear box 160 is adapted to be coupled to controller 40, by convenience connection 180 and interface 70 in a manner known to those skilled in the art through an “H” bridge drive switching device. Such as switching device allows motor operated gear box 160 to be rotated in either a clockwise or counter clockwise direction by the effective reversal of d.c. voltage polarity from power supply 30 or in the event of a.c. mains 10 failure, from drycell battery 35. Reversing rotational direction of motor operated gear box 160 causes a corresponding reversal of valve input shaft 449 thus adjusting the proportion of inlet cold water 100 and inlet hot water 110 within mixing spool 450 thus adjusting mixed outlet 444 water temperature.

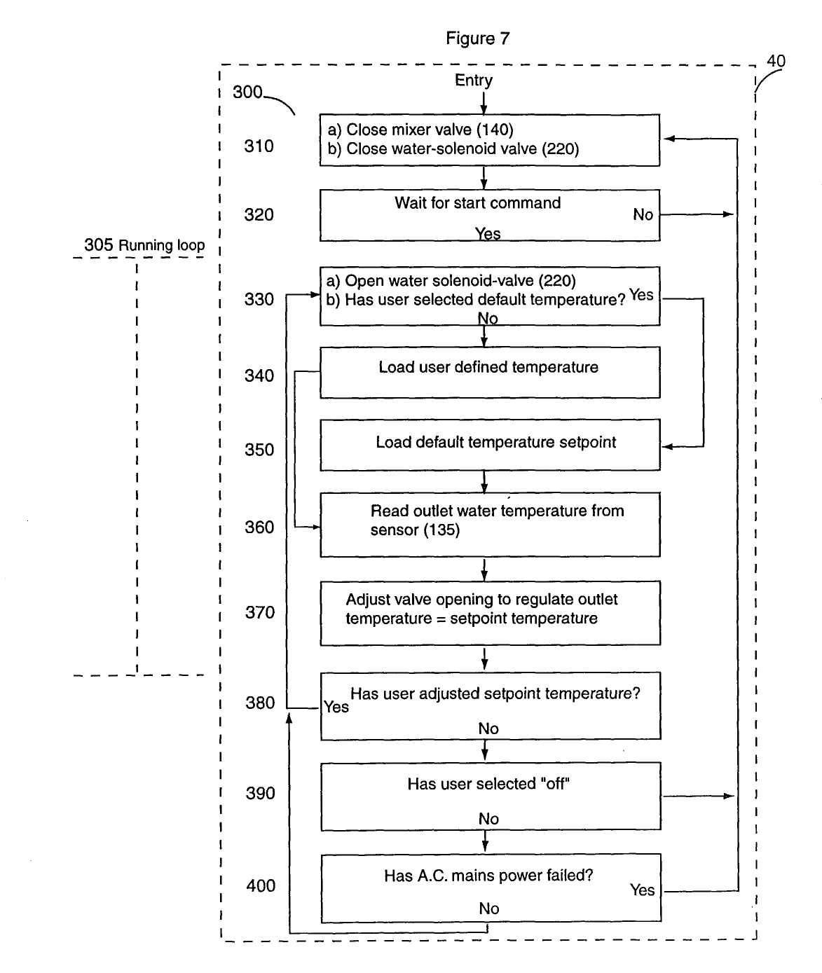

Now referring to FIG. 7, a flow chart of one embodiment of the present invention is shown detailing the operation as a said water mixing valve. The operating mode sequence 300 of controller 40 is shown. When control system 20 is connected to a.c. mains supply 10, entry to operating mode sequence 300 is started. Controller 40 executes step CLOSE MIXER VALVE 310a, causing controller 40 to operate said “H” bridge to rotate motor driven gearbox 160 in a direction to cause valve 140 to rotate to the closed or “cold” position and to execute step CLOSE WATER SOLENOID VALVE 310b, releasing water solenoid valve 61 to its normally closed condition, causing the flow of mixed water at outlet 444 to stop. Controller 40 then advances to step WAIT FOR START COMMAND 320. If no start command is received, controller 40 will loop back to step CLOSE MIXER VALVE 310a, until a start command is received. When a start command is received, controller 40 advances to step OPEN WATER SOLENOID VALVE 330a, causing water solenoid valve 61 to open and to execute step HAS USER SELECTED DEFAULT TEMPERATURE? 330b. If the user has not selected a default temperature the controller 40 will advance to step LOAD USER DEFINED TEMPERATURE 340. If the user has selected to use the default temperature, the controller 40 will skip step 340 and advance to step LOAD DEFAULT TEMPERATURE SETPOINT 350. Controller 40 will upon loading the selected or default temperature setpoint advance to step READ OUTLET WATER TEMPERATURE FROM SENSOR 360 and read the water temperature data from sensor 135. Upon completion of reading the actual water temperature, controller 40 will advance to step ADJUST VALVE OPENING TO REGULATE OUTLET TEMPERATURE=SETPOINT TEMPERATURE 370, by causing controller 40 to rotate or hold still said motor driven gearbox 160, gear train 170 and mixing valve 140 in the appropriate direction, to either increase, decrease or hold the desired water temperature at outlet 444, which is detected by water sensor 135. A person skilled in the art will recognise that there are numerous methods that can be adapted to adjust the valve position in relation to a desired setpoint. In the preferred embodiment of the invention, a high speed proportional/integral control system is desired with an optional thermal sensor phase advance algorithm. High rotational speed and acceleration of the mixing valve is desired to ensure rapid correction of mixed outlet water temperature in conditions of inlet water pressure, temperature or other disturbance. High torsional resistance drive couplings between the motor driven gearbox and mixing valve are also required. Such an arrangement provides for rapid correction of large water to setpoint temperature tolerances, while preventing valve rotational “hunting” when actual water temperature is close to the desired setpoint temperature.

Controller 40 will advance to step HAS USER ADJUSTED SETPOINT TEMERATURE? 380. If the user has adjusted the setpoint temperature by adjusting buttons on display/keypad 60, controller 40 will advance to step HAS USER SELECTED DEFAULT TEMPERATURE? 330, advancing to step LOAD USER DEFINED TEMPERATURE 340. If the user has not adjusted the setpoint temperature, the controller 40 will advance to step HAS USER SELECTED OFF? 390. If the user has selected off, by pressing a button on display/keypad 60, the controller 40 will advance to step CLOSE MIXER VALVE 310a and CLOSE WATER SOLENOID VALVE 310b. If the user has not selected off, the controller 40 will advance to step HAS A.C. MAINS POWER FAILED 400. If the a.c. mains power has failed, the controller will continue to operate under power supplied by said drycell battery 35, and advance to step CLOSE MIXER VALVE 310a and CLOSE WATER SOLENOID VALVE 310b, whereupon outlet water flow at outlet 444 will stop. If the a.c. mains power has not failed, the controller 40 will advance to step OPEN WATER SOLENOID VALVE 330a, forming the running loop 305.

Numerous modifications, variations and adaptations may be made to the particular embodiments of the invention described above without departing from the scope of the invention, which is defined in the claims.

What is claimed is:

1. An apparatus, comprising a gear motor driven mixing valve having two different fluid inputs and at least one fluid outlet, said fluid inputs adapted to be coupled to said fluid outlet in variable proportions according to process mix ratio data provided by a controller means, the apparatus comprising:
a mixing valve having a first fluid inlet, a second fluid inlet and at least one discharge outlet, for blending fluid inflows coupled respectively from said first and second fluid inlets so as to cause said mixing valve outlet to supply mixed fluid at a selected process variable ratio;
a switching device coupled to an electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;
an electric motor driven gear box adapted to be coupled to the operating shaft of said mixing valve;
optional user controls for providing process control data;
at least one process sensing probe mounted in communication with said mixing valve outlet fluid, said sensing probe adapted to be coupled to an interconnection means and controller means;
one or more optional, electrically operated fluid solenoids hydraulically coupled in series to said mixing valve outlet and electrically coupled to an interconnection means, wherein the fluid solenoid is operable in a first state wherein significant fluid flow is prevented or in a second state wherein fluid flow through the solenoid valve is substantially undisturbed, said electrical interconnection coupled to the controller means;
a controller means for receiving the process control data, comprising an input for receiving said process sensing probe telemetry, an output for switching the switching device between its first, second or third states in a predetermined sequence for inducing a polarity conditioned voltage signal, optional outputs for controlling said electrically operated fluid solenoid valve to control the flow of said mixed fluid outlet, an interface means for providing bi-directional telemetry signals to externally connected equipment;
a power supply means, coupled to the AC mains source for supplying a low-voltage, supply to the controller means;
an optional dry cell battery coupled to the controller means and low-voltage direct current power supply means.

2. An apparatus comprising an electric gear motor driven mixing valve for receiving cold and hot water supplies and providing a mixed water outlet at a default or telemetry signal defined water temperature setpoint provided by a controller means, the apparatus comprising:
a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;
an electric motor driven gear box adapted to be coupled to the operating shaft of said mixing valve;
a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;
telemetry input for providing water temperature input signals;
at least one temperature sensing probe mounted in thermal communication with said mixing valve outlet water, said temperature sensing probe adapted to be coupled to an interconnection means and controller means;
one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;
a controller means for receiving the telemetry water temperature input, an input for receiving said outlet water temperature signal from temperature sensing probe, an output for switching the switching device between its first, second or third states in a predetermined sequence for inducing a polarity conditioned voltage signal, an optional output for controlling said optional electrically operated water solenoid valves to control the flow of said water outlet, an interface means for providing communication signals to externally connected equipment;
a power supply means, coupled to the AC mains source for supplying a low-voltage, direct current to the controller means;

3. An apparatus operable in a wet, electrically hazardous environment, comprising an electric gear motor driven mixing valve for receiving cold and hot water supplies and providing a mixed water outlet to a shower, bath or other plumbing fixture, at a default or user defined water temperature setpoint provided by a controller means, the apparatus comprising:
a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;
an electric motor driven gear box adapted to be coupled to the operating shaft of said mixing valve;
a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;
user controls for providing water temperature input signals;
at least one temperature sensing probe mounted in thermal communication with said mixing valve outlet water, said temperature sensing probe adapted to be coupled to an interconnection means and controller means;
one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;
a controller means for receiving the user water temperature input, comprising an input for receiving said outlet water temperature, an output for switching the switching device between its first, second or third states in a predetermined sequence for inducing a polarity conditioned voltage signal, an optional output for controlling said optional electrically operated water solenoid valves to control the flow of said water outlet, an interface means for providing bi-directional communication signals to externally connected equipment;
a power supply means, coupled to the AC mains source for supplying a low-voltage, isolated, electrically safe, direct current to the controller means;
a dry cell battery coupled to the controller means and low-voltage direct current power supply means.

4. An apparatus as defined in claim 1, stepping motor driver wherein the switching device includes a direct current

5. An apparatus as defined in claim 1, wherein the switching device includes a bipolar stepping motor driver.

6. An apparatus as defined in claim 1, wherein the switching device includes an H bridge, direct current, motor driver.

7. An apparatus as defined in claim 1, wherein the user controls includes an LED display readout.

8. An apparatus as defined in claim 1, wherein the user controls includes an LCD display readout.

9. An apparatus as defined in claim 1, wherein the user controls includes a bi-directional communications interface.

10. An apparatus as defined in claim 1, wherein the process sensing probe comprises a thermistor.

11. An apparatus as defined in claim 1, wherein the process sensing probe comprises a semiconductor temperature sensor.

12. An apparatus as defined in claim 1, where the controller means in a microcomputer device.

13. An apparatus as defined in claim 1, wherein the isolation means includes a stepdown transformer for receiving the AC signal and providing a stepped down signal to the controller means.

14. An apparatus as defined in claim 1, wherein the isolation means includes a switch mode power supply for receiving the AC signal and providing a stepped down signal to the controller means.

15. An apparatus as defined in claim 1, wherein the dry cell battery means is a rechargeable battery.

16. An apparatus as defined in claim 1, wherein the dry cell battery means is a rechargeable battery.

17. An apparatus as defined in claim 1, wherein the dry cell battery means is a nickel cadmium battery.

18. An apparatus as defined in claim 1, wherein the dry cell battery means is a lithium ion battery.

19. An apparatus as defined in claim 2, wherein the switching device includes a direct current stepping motor driver.

20. An apparatus as defined in claim 2, wherein the switching device includes a bipolar stepping motor driver.

21. An apparatus as defined in claim 2, wherein the switching device includes an H bridge, direct current, motor driver.

22. An apparatus as defined in claim 2, wherein the telemetry input includes a user keypad input device.

23. An apparatus as defined in claim 2, wherein the telemetry input includes a communication interface port.

24. An apparatus as defined in claim 2, wherein the water temperature sensor comprises a thermistor.

25. An apparatus as defined in claim 2, wherein the water temperature sensor comprises a semiconductor temperature sensor.

26. An apparatus as defined in claim 2, wherein the water temperature sensor comprises an RTD temperature sensor.

27. An apparatus as defined in claim 2, where the controller means in a microcomputer device.

28. An apparatus as defined in claim 3, wherein the switching device includes a direct current stepping motor driver.

29. An apparatus as defined in claim 3, wherein the switching device includes a bipolar stepping motor driver.

30. An apparatus as defined in claim 3, wherein the switching device includes an H bridge, direct current, motor driver.

31. An apparatus as defined in claim 3, wherein the user controls includes an LED display readout.

32. An apparatus as defined in claim 3, wherein the user controls includes an LCD display readout.

33. An apparatus as defined in claim 3, wherein the user controls includes additional user buttons for selection of multiple setpoint temperatures.

34. An apparatus as defined in claim 3, wherein the water temperature sensor comprises a thermistor.

35. An apparatus as defined in claim 3, wherein the water temperature sensor comprises a semiconductor temperature sensor.

36. An apparatus as defined in claim 3, where the controller means in a microcomputer device.

37. An apparatus as defined in claim 3, wherein the isolation means includes a stepdown transformer for receiving the AC signal and providing a stepped down signal to the controller means.

38. An apparatus as defined in claim 3, wherein the isolation means includes a switch mode power supply for receiving the AC signal and providing a stepped down signal to the controller means.

39. An apparatus as defined in claim 3, wherein the dry cell battery means is a rechargeable battery.

40. An apparatus as defined in claim 3, wherein the dry cell battery means is a rechargeable battery.

41. An apparatus as defined in claim 3, wherein the dry cell battery means is a nickel cadmium battery.

42. An apparatus as defined in claim 3, wherein the dry cell battery means is a lithium ion battery.

43. A method for controlling a gear motor driven mixing valve having two different fluid inputs and at least one fluid outlet, said fluid inputs adapted to be coupled to said fluid outlet in variable proportions according to process mix ratio data provided by a controller means, comprising:
a mixing valve having a first fluid inlet, a second fluid inlet and at least one discharge outlet, for blending fluid inflows coupled respectively from said first and second fluid inlets so as to cause said mixing valve outlet to supply mixed fluid at a selected process variable ratio;
a switching device coupled to an electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;
an electric motor driven gear box adapted to be coupled to the operating shaft of said mixing valve;
optional user controls for providing process control data;
at least one process sensing probe mounted in fluid communication with said mixing valve outlet fluid, said sensing probe adapted to be coupled to an interconnection means and controller means;
one or more optional, electrically operated fluid solenoids hydraulically coupled in series to said mixing valve outlet and electrically coupled to an interconnection means, wherein the fluid solenoid is operable in a first state wherein significant fluid flow is prevented or in a second state wherein fluid flow through the solenoid valve is substantially undisturbed, said electrical interconnection coupled to the controller means;
a controller means for receiving the process control data, comprising an input for receiving said process sensing probe telemetry, an output for switching the switching device between its first, second or third states in a predetermined sequence for inducing a polarity conditioned voltage signal, optional outputs for controlling said electrically operated fluid solenoid valve to control the flow of said mixed fluid outlet, an interface means for providing bi-directional telemetry signals to externally connected equipment;
a power supply means, coupled to the AC mains source for supplying a low-voltage, supply to the controller means;
an optional dry cell battery coupled to the controller means and low-voltage direct current power supply means;
the method comprising the steps of:
(j) waiting for user start command;
(k) opening optional water solenoid valve;
(l) loading user defined or default outlet water temperature setpoint;
(m) reading current water temperature from sensor
(n) adjusting valve opening to regulate outlet water temperature to equal desired setpoint temperature.

44. A method of controlling an electric gear motor driven mixing valve for receiving cold and hot water supplies and providing a mixed water outlet at a default or telemetry signal defined water temperature setpoint provided by a controller means comprising:
a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;
an electric motor driven gear box adapted to be coupled to the operating shaft of said mixing valve;
a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;
telemetry input for providing water temperature input signals;
at least one temperature sensing probe mounted in thermal communication with said mixing valve outlet water, said temperature sensing probe adapted to be coupled to an interconnection means and controller means;
one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;
a controller means for receiving the telemetry water temperature input, an input for receiving said outlet water temperature signal from temperature sensing probe, an output for switching the switching device between its first, second or third states in a predetermined sequence for inducing a polarity conditioned voltage signal, an optional output for controlling said optional electrically operated water solenoid valves to control the flow of said water outlet, an interface means for providing communication signals to externally connected equipment;
a power supply means, coupled to the AC mains source for supplying a low-voltage, direct current to the controller means;
the method comprising the steps of:
(o) waiting for user start command;
(p) opening optional water solenoid valve;
(q) loading user defined or default outlet water temperature setpoint;
(r) reading current water temperature from sensor
(s) adjusting valve opening to regulate outlet water temperature to equal desired setpoint temperature.

45. A method for operating in a wet electrically hazardous environment, a electric gear motor driven mixing valve, for receiving cold and hot water supplies and providing a mixed water outlet to a shower, bath or other plumbing fixture, at a default or user defined water temperature setpoint provided by a controller means comprising:
a mixing valve having a nominally cold water inlet, a nominally hot water inlet, at least one discharge outlet for blending cold and hot water inflows coupled respectively from said cold and hot water inlets so as to cause said mixing valve outlet to supply mixed water of a selected temperature;
an electric motor driven gear box adapted to be coupled to the operating shaft of said mixing valve;
a switching device coupled to the electric motor operated gear box, the switching device being operative in either a first state wherein significant current flow through the motor is prevented or a second state wherein current flow through the motor causes rotation in a first direction or a third state wherein current flow through the motor causes rotation in a direction opposite to the first direction;
user controls for providing water temperature input signals;
at least one temperature sensing probe mounted in thermal communication with said mixing valve outlet water, said temperature sensing probe adapted to be coupled to an interconnection means and controller means;
one or more optional, electrically operated water solenoids hydraulically coupled in series to said mixing valve outlet and electrically coupled to an interconnection means, wherein the water solenoid is operable in a first state wherein significant water flow is prevented or in a second state wherein water flow through the solenoid valve is substantially undisturbed, said electrical interconnection coupled to the controller means;
a controller means for receiving the user water temperature input, comprising an input for receiving said outlet water temperature, an output for switching the switching device between its first, second or third states in a predetermined sequence for inducing a polarity conditioned voltage signal, an optional output for controlling said optional electrically operated water solenoid valves to control the flow of said water outlet, an interface means for providing bi-directional communication signals to externally connected equipment;
a power supply means, coupled to the AC mains source for supplying a low-voltage, isolated, electrically safe, direct current to the controller means;
a dry cell battery coupled to the controller means and low-voltage direct current power supply means;
the method comprising the steps of:
(t) waiting for user start command;
(u) opening optional water solenoid valve;
(v) loading user defined or default outlet water temperature setpoint;
(w) reading current water temperature from sensor
(x) adjusting valve opening to regulate outlet water temperature to equal desired setpoint temperature.
